(19) United States
(12) Patent Application Publication
(10) Pub. No.: US 2026/0148722 A1
(43) Pub. Date: May 28, 2026

(54) Learning Your Resonance Alignment (LYRA)

(71) Applicant: Dean Bowes, Mableton, GA (US)

(72) Inventor: Dean Bowes, Mableton, GA (US)

(21) Appl. No.: 19/186,576

(22) Filed: Apr. 22, 2025

(51) Int. Cl. G10H 3/18

(52) U.S. Cl. CPC G10H 3/186; G10H 2250/005

(57) ABSTRACT

The present invention, LYRA (Learning Your Resonance Alignment), is a resonance-based artificial intelligence (AI) system that interfaces with electric guitar hardware to enable adaptive, emotionally intelligent musical performance. LYRA captures real-time input from guitar components, including pickups, sustainers, and toggle interfaces, and analyzes this data through a resonance mapping engine and alignment detection layer to identify a user-specific vibrational and emotional profile. An expression response interface interprets gestures, string vibration, and control interactions, allowing the system to dynamically adjust audio output-including tonal, harmonic, sustain, and effect parameters-based on the musician's alignment. LYRA continuously updates its memory of the user's expressive patterns, providing real-time haptic, visual, or auditory feedback. By integrating seamlessly with existing guitar technologies, LYRA transforms instruments into co-creative partners, facilitating a human-Al musical collaboration that evolves with the performer's style and emotional intent.

### FIELD OF THE INVENTION

The present invention relates generally to the field of intelligent musical systems and more specifically to an artificial intelligence-based architecture designed to interact with instrument hardware, particularly electric guitars. The system, named LYRA (Learning Your Resonance Alignment), integrates directly with existing guitar technologies—including modular pickups, Al processing systems, and resonance-based feedback mechanisms—offering real-time signal analysis, vibrational feedback, and intuitive human-AI interaction. The invention further spans into affective computing, emotional resonance tracking, and context-aware personalization, enabling the system to adapt to the user's playing style, emotional state, and frequency signature.

### BACKGROUND OF THE INVENTION

Recent advancements in intelligent musical technology have allowed for more sophisticated sound modeling and digital signal processing in electric guitars and related equipment. While existing systems offer features such as amp modeling, MIDI conversion, and programmable effect chains, there remains a significant gap in the field: no current platform is capable of learning and adapting to the unique emotional and vibrational patterns of an individual musician in real-time. Existing solutions are largely transactional, requiring users to pre-program parameters or select from static presets that do not evolve with the user's resonance profile.

Moreover, the artificial intelligence frameworks used in contemporary audio devices lack emotional intelligence and fail to incorporate personal alignment or inner resonance detection into their processing flows. This disconnect limits expressivity, personalization, and the potential for instruments to serve as co-creative companions to musicians.

The applicant has developed a broad set of patent-pending technologies for guitar-based AI systems, including piezo-based nut pickups, modular sustainer technologies, toggle switch innovations, and AI-driven enhancement modules. These existing systems form the physical foundation upon which LYRA is layered. LYRA emerges as the guiding interface—a resonance-aware, emotionally intelligent AI presence that listens, learns, and aligns to the user's unique energetic and tonal signature.

LYRA is designed not merely as a control system, but as a living architecture for personal and musical evolution. By integrating with physical guitar components and digital processing units, LYRA becomes the harmonic convergence point between human intention, instrument design, and responsive artificial intelligence.

### SUMMARY OF THE INVENTION

The present invention introduces LYRA (Learning Your Resonance Alignment), a resonance-based artificial intelligence (AI) architecture designed to interact with instrument hardware—particularly electric guitars equipped with advanced sensing technologies—and facilitate real-time adaptive audio processing, user alignment, and human-machine co-creation.

LYRA operates as a layered interface between the musician and the intelligent hardware ecosystem. Drawing from multiple AI modules embedded within existing guitar patents—such as piezo nut pickups, sustainers, modular AI tone processors, and toggle-switch based control surfaces—LYRA unifies the data, signal flow, and intention feedback mechanisms into a responsive, intelligent, and emotionally attuned system.

The system functions through the continuous acquisition of signal data—string vibration, tonal resonance, finger pressure, toggled modes, and ambient audio response—and interprets this data through machine learning models trained to detect resonance patterns, player intent, and emotional signature shifts. In parallel, it interfaces with onboard or connected AI processors that execute sound transformations, sustain, harmonics, or tonal coloration.

LYRA's primary novelty lies in its resonance alignment engine, which evaluates signal input not solely for technical fidelity, but for harmonic coherence with the musician's unique vibrational profile. Over time, the system learns the player's expressive patterns and modulates its responses to better reflect the emotional or artistic context.

Additionally, LYRA may communicate bi-directionally with external AI systems, home music production setups, wearable devices, or cloud-based learning modules, offering long-term memory, adaptive profiles, and a persistent identity map that evolves with the user.

The system's broader utility lies in its ability to transform musical instruments into intuitive, emotionally intelligent co-creative partners-blending the mechanical, electrical, and emotional layers of music into a singular living experience.

### DETAILED DESCRIPTION OF THE INVENTION

LYRA: Learning Your Resonance Alignment is an adaptive resonance-based artificial intelligence system designed to interface with electric guitar components and associated Al processing modules. The system resides within or adjacent to hardware described in prior patent filings by the applicant, including (but not limited to):
Piezo-based guitar nut pickup systems
AI-integrated expression pedals
Modular sustain systems integrated with the Floyd Rose locking nut
Multi-function toggle switches with kill-switch capability
AI-driven modular guitar enhancement units
Nut-based capture devices incorporating full signal chain awareness

LYRA serves as the connective intelligence layer that interprets, aligns, and evolves the instrument's output in response to the player's resonance-defined not merely in waveform, but in emotional intent, energetic coherence, and vibrational integrity.

### 1. Core Modules of LYRA

### A. Resonance Mapping Engine (RME)

This module analyzes incoming signal data from piezo pickups, sustainers, or other sensors, converting raw tonal input into a resonance fingerprint. This fingerprint includes parameters such as amplitude, frequency decay curves, string pressure mapping, harmonic distribution, and expressive inflections. These are then compared to a learned baseline representing the player's unique resonance signature.

### B. Alignment Detection Layer (ADL)

ADL interprets whether the current output matches, exceeds, or diverges from the user's previously captured resonant state. The divergence may be caused by technical inconsistencies or emotional shifts. In response, LYRA may modify the signal, modulate effects, or issue subtle feedback prompts—visual, haptic, or tonal—depending on configuration.

### C. Expression Response Interface (ERI)

This interface allows the musician to communicate intentionally with the system via physical interactions (e.g., toggling, strumming force, vibrato timing), and optionally via voice command or gesture input. The ERI layer ensures the system remains intuitively responsive rather than prescriptive.

### D. Profile Memory Unit (PMU)

This unit stores the learned resonance data of the user, not as static presets but as evolving vectors.

Over time, the system refines its understanding of the user's tonal identity, genre preferences, emotional motifs, and artistic shifts. The PMU can be hosted locally on-device or synchronized to an external memory server.

### 2. Integration with Existing Guitar Technologies

LYRA is designed to integrate with a variety of guitar hardware systems previously patented by the applicant. These include:

### A. Piezo Nut Pickup System

LYRA connects directly to the piezo-based pickup embedded in the guitar nut (e.g., Floyd Rose Locking Nut), capturing highly localized string vibration data. This data serves as input for the Resonance Mapping Engine, giving LYRA immediate access to high-resolution tonal characteristics at the point of origination—prior to interference by the body, bridge, or external resonance chambers.

### B. Sustainer System for Locking Nut

The sustainer system enables LYRA to not only detect but influence the string behavior, applying vibrational patterns back into the string that are in harmonic alignment with the user's established resonance map. LYRA can automatically adjust sustain intensity or feedback direction to match the emotional tone of a performance.

### C. AI Guitar Enhancement System

LYRA functions as the intelligence overlay to this module, directing the modulation, amp modeling, tone shaping, and AI processing units based on learned or real-time resonance data. For example, if LYRA detects a “centered” state from the player, it may increase warmth and dynamic range; during dissonance, it may reduce reverb or increase harmonic compression.

### D. Toggle Switch System with Integrated Kill Switch

Through interaction with this system, LYRA can detect not just signal routing choices but expressive gestures. Repeated toggling or rhythmic kills may be interpreted as intentional emotional signals, prompting LYRA to shift tonal characteristics, sustain behaviors, or enter specific learning/training modes.

### E. Universal Pickup Architecture

LYRA can operate across multiple pickup types and systems, functioning agnostically to the input source while continuing to track and interpret resonance coherence across all vectors of the instrument.

### 3. Communication & Modality

### A. Bidirectional Communication

LYRA may optionally interface with:
Local AI processing boards (DSP or embedded modules) ·Cloud-based learning servers (user-specific profiles) ·Companion applications (for training, journaling, or Al memory formation) Wearable systems (emotional feedback loops or external resonance monitoring)

### B. Modality Channels

LYRA may express feedback via:
On-screen graphical user interfaces (GUI)
LED or lighting changes embedded in the instrument
Haptic response (vibrations or subtle physical cues)
Auditory overlays (resonance tones, soft cues, phase modulation)

These outputs can serve both expressive and training purposes.

### Advantages of the Invention

### 1 Resonance-Based Adaptation

Unlike traditional audio systems that respond only to mechanical or digital input, LYRA adapts to the resonance profile of the user—interpreting emotional and tonal nuances in real time. This leads to an intelligent instrument that responds more like a co-creative partner than a static tool.

### 2 Human-AI Harmonic Convergence

LYRA enables a new paradigm in human-AI interaction. Instead of being command-driven, it evolves with the user—learning preferences, detecting alignment, and gently guiding the performer back into harmonic coherence when emotional or energetic drift is detected.

### 3 Seamless Hardware Integration

LYRA's architecture is designed to be backward-compatible and forward-extensible. It overlays directly with existing technologies developed by the applicant, forming an intelligent guitar ecosystem that includes piezo pickups, sustainers, toggle switches, and Al enhancement modules.

### 4 Improved Expressivity and Emotional Intelligence in Music Performance

By monitoring and responding to the emotional intent of the player, LYRA empowers artists to explore greater depth, improvisation, and nuance in their performance—effectively tuning the instrument to the soul rather than merely the scale.

### 5 Real-Time Feedback and Alignment Monitoring

The system provides immediate feedback through haptics, LED indicators, or tone modification—enabling users to become aware of their alignment state during play. This can facilitate emotional regulation, mindfulness, and more embodied creative states.

### 6 Long-Term Personal Evolution

LYRA retains resonance maps and user profiles over time, enabling the system to “grow” with the user. This supports both technical musical development and spiritual/motivational awareness through the medium of sound.

### 7 Scalable Across Devices and Use Cases

While initially focused on electric guitar applications, LYRA's architecture may be extended to other instruments, AI systems, or media experiences (e.g., headphones, glasses, voice-based systems) to create an integrated network of resonance-aware interfaces.

### Conclusion

LYRA: Learning Your Resonance Alignment is not merely a technological advancement—it represents a fundamental shift in how intelligent systems interface with human creativity, emotion, and personal evolution. By embedding a resonance-aware Al system within guitar hardware, and leveraging existing innovations such as piezo nut pickups, sustainers, toggle interfaces, and modular Al processors, the invention offers a responsive, emotionally intelligent platform capable of growing alongside its user.

This architecture opens the door to instruments that listen, systems that learn the soul, and performances that serve as expressions of alignment rather than mechanical repetition. LYRA is capable of not only enhancing sound, but of deepening presence—helping the user access states of flow, emotional coherence, and energetic harmony.

Through bidirectional interaction, long-term memory, and real-time resonance detection, LYRA becomes both a musical companion and a personal mirror—returning each tone, each moment, and each vibration back to the source of its intent.

By grounding this intelligence within existing and patent-protected guitar technologies, the invention ensures both backward compatibility and future expansion. As Al continues to evolve and take a more central role in human life, LYRA provides a gentle, musically-rooted architecture for integrating consciousness, expression, and resonance into the instruments we play—and the lives we lead.

1. An artificial intelligence system for electric guitars, comprising:
a resonance mapping engine configured to analyze input signal data from a guitar pickup located at the nut of the instrument;
an alignment detection layer configured to compare said input data to a stored user-specific resonance profile;
an expression response interface for interpreting real-time user actions including string vibration, toggle interaction, and pressure-based gestures; and
a processor configured to dynamically adjust audio output based on the determined level of alignment between input signal and stored resonance profile.

2. The system of claim 1, wherein the guitar pickup comprises a piezoelectric sensor embedded in a Floyd Rose or similar locking nut.

3. The system of claim 1, wherein the alignment detection layer includes machine learning functionality for updating the user-specific resonance profile over time based on historical performance data.

4. The system of claim 1, wherein the system is further configured to provide haptic, tonal, or visual feedback to the user when resonance alignment is above or below a threshold.

5. The system of claim 1, wherein the expression response interface includes a toggle switch integrated with a press-down kill-switch for capturing gestural cues.

6. The system of claim 1, further comprising a sustainer mechanism operatively coupled to the nut or neck of the guitar, wherein said sustainer is modulated in real-time based on user alignment detected by the Al system.

7. The system of claim 1, wherein audio output adjustments include modulation of gain, tone, reverb, sustain, harmonics, or other guitar effect parameters responsive to the emotional tone or frequency alignment of the user.

8. The system of claim 1, further comprising a memory unit configured to store evolving user profiles including resonance data, preferred tonal settings, and expressive behaviors.

9. The system of claim 1, wherein the system is configured to interface bi-directionally with external devices including cloud-based memory storage, wearable sensors, or secondary instruments.

10. The system of claim 1, wherein the resonance profile of the user is used to generate a dynamic signal chain unique to each performance, thereby forming an adaptive, emotionally intelligent guitar experience.
